(19) United States
(12) Patent Application Publication
(10) Pub. No.: US 2024/0383672 A1
(43) Pub. Date: Nov. 21, 2024

(54) HIGH PERFORMANCE AERONAUTIC CONTAINER

(71) Applicant: SWISS AIRTAINER SA, Payerne (CH)

(72) Inventors: Marco MARTIN, Yverdon-les-Bains (CH); Eduard SELIGMAN, Bernex (CH)

(21) Appl. No.: 18/696,564

(22) PCT Filed: Sep. 27, 2022
(86) PCT No.: PCT/IB2022/059174

§ 371 Date: Mar. 28, 2024

(30) Foreign Application Priority Data
Sep. 29, 2021 (EP) 21199655.8

(51) Int. Cl. B65D 88/14; B65D 88/74; B65D 90/02

(52) U.S. Cl. CPC B65D 88/14; B65D 88/745; B65D 90/022

(57) ABSTRACT

The present invention relates to a thermo controlled container (1) for aircrafts having compact batteries with a low consumption temperature control system and a high performance thermal isolation. The present invention also describes a process for the manufacture of such a container.

### TECHNICAL DOMAIN

The present invention concerns a container for shipping sensitive and/or high added-value products by air. It relates in particular to thermally regulated aeronautic containers having high energetic performances and allowing cost effective shipment of sensitive products, such as pharmaceutical products.

### RELATED ART

The shipment of sensitive products requires that the temperature is maintained at or under a certain level, or within a certain range of temperatures along the time of travel. Passive means are usually used to limit the internal temperature variation of the container over time. Such passive means include for example Phase Changing Material (PCM) or thermal isolating materials, such a polyurethane or equivalent material, which is combined to the walls of the container. The thickness of the isolating material limits the remaining volume of the container that can be actually used for storing freight. It results in addition of an increase of the weight of the container, which also limits the amount of product that can be shipped.

Passive means need to be combined to an active thermal regulation system for the shipment of the most sensitive products. Such active system is part of the container, it participates to its extra weight and occupies space. In addition, it should be able to work autonomously, which necessitates the presence of a source of energy such as batteries.

It is a recurrent problematic to improve the rentability of the shipment, while controlling the internal temperature of the container all over the transportation time. The rentability of the shipment may be directly related to the maximum possible loading mass, the internal loading volume, the autonomy, the container tare weight, or a combination of several of these parameters. The performances of the material used for maintaining a controlled temperature inside the container is most often related to its weight, cost and/or hindrance. For example, an efficient passive thermal isolation is most likely heavier than a less efficient one or may occupy more space. Although a good passive thermal isolation may allow to reduce the dimensions of the active system, including its weight, or its cost, or its consumption, the global benefit often appears mitigated due to the extra-weight or hindrance of the passive arrangement. On the contrary, a light and thin thermal isolation may require a more powerful, and thus a larger Temperature Control System to compensate the variations of the temperature inside the container. This results on either an increase of consumption and/or weight due to the necessary batteries, and/or a limitation in autonomy. The batteries associated to the Temperature Control System should be adapted to its energy consumption, considering also the degree of autonomy it should have. The most powerful Temperature Control System needs large and heavy batteries, which is prejudicial to the Tara weight of the container and/or its loading volume. It is in addition highlighted that the higher the energy consumption is, the worse the CO₂ footprint is. It is also highlighted that a heavy Tara weight negatively impacts the CO₂ footprint during the air transportation.

It is thus a challenging task to decrease the weight and/or hindrance of the Temperature Control System, including the batteries, which relates to an active means, while maintaining, or even decreasing, the weight and/or hindrance of the passive thermal means of isolation. It is also globally a challenging task to decrease the overall weight and/or hindrance of the container, including the isolation and the batteries, while maintaining the internal loading volume and the degree of autonomy.

Regarding the shipment of sensitive products, it is in addition most often necessary to provide a strong reliability so as to avoid any defects. For example, redundancy or over-dimensions of the key elements may be necessary.

In the field of the aircraft transportation, the regulation determines most of the parameters of the containers. In particular, their shape, dimension, mechanical resistances, fire resistance, fluid leakage and several other performances should comply with strict norms and regulations. One of the major restriction coming from the regulation concerns the position of the container center of gravity (CoG) that must be located close to the base center. This is often an issue when the batteries are located in the Equipment Bay and need to be balanced by a dead-weight on the opposite side of the container. This lead to a significant increase of the container overall weight. It results that decreasing the weight of an aircraft container while complying to all the regulations increases the difficulty compared to other technical fields. It should also be considered that sensitive products such as the pharmaceutical products also needs to comply to strict regulations, at least concerning the storage and shipping conditions.

Beside the thermal performances of an aircraft container, its flexibility of use is also an important parameter. The constraints related to the logistic chain may be very high, regarding at least the time of travel, the geographical areas, the storage conditions at airports, the amount of freight that needs to be shipped, etc. The modulation of the aircraft container on demand thus appears an advantage compared to traditional standard containers. In addition, the limited performances of some containers requires that specific infrastructures are built at the airports, to maintain the proper storage conditions.

Document WO2012047183 discloses Tracking Environmental Deviation System Box (TEDSBOX) having a temperature control system, batteries and passive means of temperature regulation such as an isolation. The internal space is organized so as to optimize the internal storage space. The power supply is integrated to the base of the cargo box to optimize the position of the Center of Gravity. The balance issue appears in service when the batteries are placed in the Equipment Bay. The dead weight necessary on the opposite to compensate them. Also, the power and dimensions of the Temperature Control system is not really object of the optimization. It results that the weight of the batteries remains an important issue.

Due to the mechanical resistance required for an aeronautic container, in particular through the regulation, metallic structure such as aluminum is usually preferred. Such a metallic structure limits the thermal performances of the container, due to the high thermal conductivity of the metal. In addition, the weight of the metallic structure also appears as a limitation. The document WO2004045987 discloses a craft container based on metallic panels between which an isolating foam is spread.

The document U.S. Pat. No. 5,979,684 discloses a cargo container made with sandwich panels based on fiber reinforced plastic, and a light foam core material, adapted for thermal isolation of the freight. However reinforcing beams are necessary to obtain the requested resistance of the container, which provides various free spaces in the sandwich panel structure. It results that an optimal thermal isolation can be difficult to obtain.

There is thus room to improve the performances of the craft containers, from the weight point of view, or for other aspects such as the flexibility, the autonomy, the shipment cost and sustainability, production and maintenance cost and energy consumption.

### SHORT DISCLOSURE OF THE INVENTION

An aim of the present invention is the provision of an aircraft container, that overcomes the shortcomings and limitations of the state of the art. It is in particular the aim of the present invention to provide a temperature regulated container for aircrafts, being lighter and more reliable than the known containers. It results that the CO₂ emission and the energy consumption has less impact on the environment. This also provides the possibility of more cost effective shipments of temperature sensitive products, without loss of quality. It is thus the objective of the present invention to provide an aircraft container, the weight of which is reduced by 10%, 20%, 30%, 40% or more compared to the known containers. It is the objective to provide an aircraft container having a weight of around 500 kg, or 400 kg or less, while corresponding to all the aircraft regulations applicable to such containers, where the traditional containers have a weight of around 650 kg or more.

It is an object of the present invention to provide an aircraft container having improved passive thermal performances. It is in particular aimed at providing a container the walls of which have a thermal conductivity of around 0.03 W/mK or around 0.02 W/mK or less, while corresponding to all the aircraft regulations applicable to such containers. It is a further aim to provide a container having an overall thermal conductance of less than around 4 W/K, or 3.5 W/K, or less.

Another aim of the present invention is to provide a temperature regulated container for aircrafts, having a better flexibility of use. The container is better adapted to the logistic constraints. It can also be used under severe or demanding conditions, without specific surrounding infrastructures or with limited specific surrounding infrastructures. To this extend, it is aimed at providing a container having larger autonomy and/or being adapted for longer storage conditions, even in absence of dedicated infrastructures.

Another aim of the invention is the provision of a process for making an aircraft container, having weight and/or thermal performances mentioned above.

According to the invention, these aims are attained by the object of the independent claims, and further described by the subject-matter of the dependent claims.

With respect to what is known in the art, the present aircraft container allows a more efficient and flexible container for shipment of sensitive and/or high added value products, such as pharmaceutical products.

### SHORT DESCRIPTION OF THE DRAWINGS

Exemplar embodiments of the invention are disclosed in the description and illustrated by the following drawings:

FIG. 1: Perspective view of a container according to an example of the present invention

FIG. 2a: Schematic transversal view of a container according to an example of the present invention

FIG. 2b: Schematic view of an insulating wall of a container according to the present invention

FIG. 3a: Exploded schematic view of a container according to an embodiment of the present invention

FIG. 3b: Exploded schematic view of a container according to another embodiment of the present invention

FIG. 4: Schematic perspective view of a tray for batteries according to an example of the present invention

FIG. 5: Schematic exploded view of a tray for batteries according to an example of the present invention

### EXAMPLES OF EMBODIMENTS OF THE PRESENT INVENTION

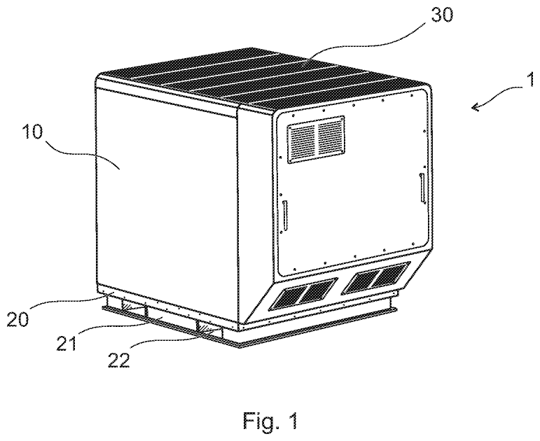

With reference to FIGS. 1, 2, 3a and 3b, the container 1 of the present disclosure comprises a storage box 10, also known as a thermally insulated chamber. The storage box is defined by walls 11 defining an internal storage volume 12, corresponding to the payload compartment, dedicated to the freight. Some or all of the walls are thermally insulated. The walls 11 comprise lateral walls and a top wall defining a roof. The container 1 may also comprise technical volume 13, comprising at least some of the technical devices used for actively controlling the temperature inside the container 1. As an example, the technical volume 13 may comprise one or more of a Temperature Control System (TCS) 14 and an Electrical Power System (EPS) 15, adapted to manage the energy from various sources, such as battery or solar panels. The technical volume 13 may comprise all or part of the Temperature Control System (TCS) 14. This includes for example the necessary compressor, evaporator, condenser and the corresponding pipes and fans. The technical volume 13 may also be used to lodge one or several extra battery modules. For example, up to 3 extra battery modules can be lodged in this technical volume. The technical volume is separated from the storage volume 12 by an internal wall, which can be also be thermally insulated. Such internal wall may be provided with any openings, air ducts, filters, sensors, necessary to allow the Temperature Control System (TCS) 14 to actively regulate the thermal conditions of the storage volume 12.

The container 1 has a base 20 on which is arranged the storage box 10, comprising forklift tunnels 22 and a central housing 21, placed between the two forklift tunnels 22. The central housing 21 is a hollow space adapted to receive the batteries 210 or any equivalent storage means of electrical power. Although the base 20 may have additional hollow space outside the forklift tunnels 22, meaning on lateral positions of the base 20 these lateral hollow spaces are preferably kept empty to maintain the weight of the container under a certain limit.

According to an embodiment, the top surface of the base 20 is flat and the bottom surface of the storage box 10 is also flat, so that the lateral empty spaces of the base 20 cannot receive freight.

Thus, all the batteries 210 of the container 1 are housed in the reduced spaced between the two forklift tunnels 22. Such a disposition necessitates to limit the hindrance of the batteries 210 so that all the batteries are lodged in the central housing 21. In addition, due to a less hindrance of the batteries, a more loading weight may be available. The height of the batteries 210 is also limited. The storage volume 12 is thus improved. It is here understood that the reduced size of the batteries 210 is possible due to the high thermal performances of the walls 11 of the container 1.

The TCS 14 and the power delivered by the batteries 210 are correlated. In particular, the TCS 14, and more precisely, its compressor (not shown) is a low weight and low consumption compressor. The compressor may advantageously be a micro-rotative compressor. Its weight is preferably below 1 kg, or around 800 g or below. The TCS 14 may comprise two or more compressors for a better redundancy and a better reliability, without negative impact on the amount of freight. Alternatively or in addition, more than 1 TCS may be included for a more complete redundancy. In other words, the weight gain due to the compact and light thermal active system can be exploits for a better reliability. The TCS 14 may alternatively or in addition comprise two independent electronic control and command arrangements. Other redundancy can be applied, such as communication arrangements, without prejudice of the amount of freight. It is here highlighted that such reduced size of the TCS depends on the thermal performances of the walls 11.

According to an advantageous embodiment, the TCS 14, and in particular its compressor, or its set of compressors, allows a very precise temperature control inside the container 1. The rotation speed of such a compressor, mainly when it is a micro-rotative compressor, can be closely related to the temperature gap or the temperature variation. In consequence, the energy consumption is better controlled. At least, peaks of energy consumption can be avoided or limited. This arrangement provides the advantage that beside the global low average consumption, the temporary maximal energy consumption can also decrease, so that the batteries do not need to provide too high instantaneous power. Such a smooth temperature management thus allows to decrease the weight and/or hindrance of the batteries, and/or to decrease their cost. This also allows to choose electrical components (connectors, wires, relays, fuses, etc) with a lower maximal current limit, thus reducing their size, their mass and/or their price.

According to a specific arrangement, the TCS 14 is connected to some integrated or remote computational means adapted to anticipate the temperature variations so that the compressor can be activated in anticipation to maintain the temperature at the right level with lower energy consumption since it avoid peaks of consumption. Such an integrated or remote computational means can rely on external thermal sensors arranged on the container or at a remote location. The temperature can also be smoothly managed to anticipate a strong and fast variation. This can be the case for example at the arrival of the aircraft at a warm country, or when storing the container 1 outside, under sun, or on the contrary under very cold conditions.

Flexibility and/or reliability is thus increased without prejudice on the weight of the container 1, and/or on the weight of freight.

It is understood that the TCS 14 denotes any thermal control system, including refrigeration systems and heating systems. The container of the present disclosure is thus provided with a cooling or a heating system or both of a cooling and heating system. To this end, reduction of the global weight of the container allows to include both cooling and heating systems, increasing in consequence its performances and/or its flexibility.

The container of the present disclosure can in addition comprise one or several solar panels 30, either integrated or combined to one or more of its walls. The solar panels 30 are preferably placed on the top surface of the container 1. When integrated to a wall, it can be integrated during the manufacturing process of the wall. Alternatively, it can be integrated to the wall during post manufacturing steps. When it is combined to a wall, the solar panel 30 can be permanently linked to the container, by any suitable means such as gluing, welding, screwing and equivalent. Alternatively, it can be removably linked to the container 1 so that it can be easily added or removed on demand, according to the freight conditions or maintenance purposes. Fast clamping means or any other fixation means may be used to this end. The solar panel 30 is electrically connected to the batteries 210 and/or to the active thermal system or parts of the active thermal system such as the Electrical Power System (EPS).

The surface of the solar panels 30 may approximately correspond to the surface of the top of the container 1. The solar panels can for example occupy half of the top surface or 70% or 80% or more than 90% of the top of the container 1. As an example, the surface adapted to receive one or several solar panels 30 can be of around 2 m² to 3 m² for standard small container, of the RKN type. For such a surface, the weight of the solar panels 30 is kept to around 5 to 7 kg. It is understood that the surface occupied by the solar panels, as well as their properties, can easily be adapted according to the use. Preferably, a container comprises at least two independent solar panels so as to provide redundancy.

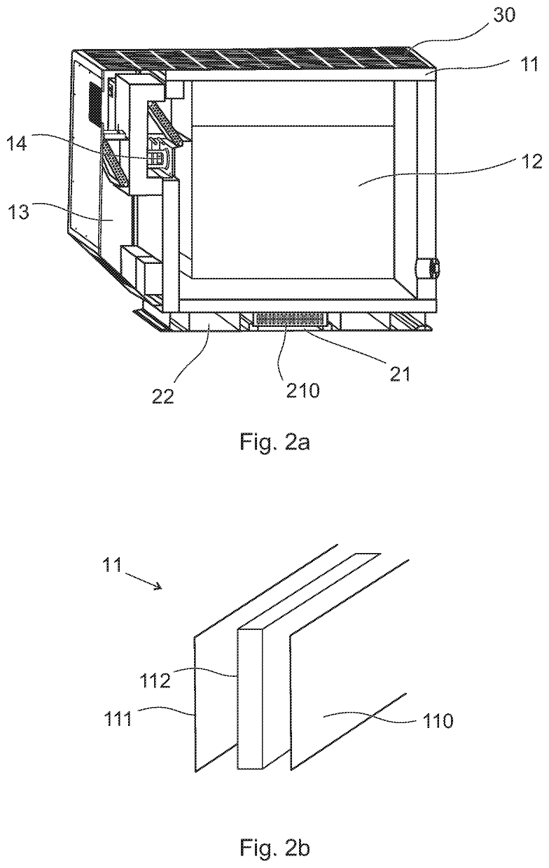

As mentioned above, the size and weight of the batteries 210, as well as the size and weight of the TCS 14, strongly depends on the thermal performances of the walls 11 of the container 1. The walls 11 of the present container 1 typically comprise at least a first panel 110 and a thermally insulating material 112 combined to the first panel 110 (FIG. 2b). Preferably a wall 11 of the container 1 comprises a first panel 110 and a second panel 111 facing each other and an insulating material 112 arranged between the first and the second panels. Using thicker insulating material already used in the current containers, results in an increase of weight and reduces the volume available for the freight. Usual thermal insulating materials in this field have a density of around 80 kg/m³ or even higher. Increasing the amount of such insulating material thus increases the global weight as well as it reduces the storage volume of the container 1. The insulating material 112 is thus selected among materials having a density lower than 60 kg/m³, preferably lower than 50 kg/m³ or even around 30 kg/m³ or lower. A polyurethane based foam can be used as such.

Beside its density, the insulating material is selected to have a lower thermal conductivity compared to the commonly used material. The thermal conductivity of the usual insulating material is around 0.03 W/mK. The insulating material 112 of the present disclosure is preferably selected among materials having a thermal conductivity lower than 0.03 W/mK, preferably lower than 0.02 W/mK, or around 0.018 W/mK or lower.

For an improved thermal isolation, the insulating material 112 of the present disclosure has both a density lower than 60 kg/m³ and a thermal conductivity lower than 0.03 W/mK, or 0.2 W/mK.

As an example, the selected insulating material 112, has a density of around 30 kg/m³ and thermal conductivity of 0.02 W/mK or lower, such as around 0.018 W/mK or 0.016 W/mK.

According to a preferred embodiment, the insulating material is a rigid panel or a combination of rigid panels which can take all the internal space of the first panel 110 and the second panel 111.

Although the insulating material 112 can be combined to the traditional metallic structures of the containers, it is preferably combined to a lighter material such as a polymeric or a multi-component material, such as composite material or a combination thereof. The aluminium currently used as structure for the container 1, has a high thermal conductivity which is prejudicial to the thermal performances. In addition, it is heavy and thus represents an issue with regards to the tare weight.

The insulating walls 11 of the container 1 preferably comprise an insulating material 112 combined to a non-metallic structural panel 110, 111. The insulating material 112 has most advantageously the density and/or the thermal conductivity above-mentioned. The non-metallic structural plate preferably comprises carbon fibre or glass fibre or composite materials or a combination thereof. This provides the advantage of a lighter structure having a lower thermal conductivity. The non-metallic structural panels 110, 111 provide the mechanical resistance of the container 1. They represents the skin of the assembly in case of a sandwich arrangement.

It is thus understood that the insulating walls 11 of the container 1 can either comprise a traditional metallic structure combined to an improved isolating material 112 having the density and the thermal conductivity described here, or comprise a traditional isolating material combined to a non-metallic structure above-mentioned.

In a preferred embodiment, the insulating walls 11 of the present container 1 has both an improved insulating material 112 as above described and a non-metallic structure. In particular, the improve insulating material 112 has the form of rigid panels and the structural arrangement has the form of non-metallic panels, forming a sandwich structure together with the panels of the thermal isolating material. More particularly, the non-metallic panels of the structural arrangement denotes panels made of composite material.

Regarding the structure of the container 1, it should resist to a load of several tons, according to the corresponding regulation. Where a composite material comprising fibres is used instead of a metallic structure, the same resistance should be demonstrated.

According to an embodiment, the internal space of the walls 11, defined by the panels of the structural arrangement, is free of any reinforcing element, such as beams, so that the panels of insulating material 112 can occupy all the free space between the panels of the structural arrangement, or at least more than 90%, or more than 95% or more than 99% of the space between the panels of the structural arrangement. Thus, the panels of insulating material 112 can be combined to the first panel 110 of the structural arrangement before the second panel 111 of the structural arrangement is further added on the opposite face of the panels of insulating material 112. It results that the quality of the thermal isolation can easily be visually controlled during the production of the walls 11. In addition, the dimensions of the panels of isolating material 112 is well adapted to the panels of the structural arrangement, which avoids any voids or lack of insulation material.

In addition, once the panels of the structural arrangement 110, 111 and the panels of insulating material 112 are arranged together, they can be processed in one step under suitable conditions of pressure and temperature. In other words, there is no necessity to firstly arrange the panels of the structural arrangement and maintain them at a proper interval and fill the internal space with a foam in a separate step, as it is currently done with none rigid insulating material.

The insulating material 112, as rigid panels, participates to the resistance of the walls 11. This means that in absence of reinforcing internal elements such as internal beams, the rigid panels of insulating material provides the necessary reinforcing action. Thus, the performance of the thermal insulation is high, since there is no voids of insulating material, while the resistance of the wall remains good.

According to an embodiment, the panels of the structural arrangement, in particular when they are made on non-metallic material, can comprise external reinforcing structures. Such an external reinforcing structure can be for example local higher thickness of the non-metallic material. Alternatively, the external reinforcing structure can comprise beams, which can be metallic or non metallic. For example, angled metallic bars can be arranged at the edges between two contiguous walls or between the lateral walls or some of the lateral walls and the top surface.

So as to improve the global mechanical resistance of the non-metallic panels of the structural arrangement, forming the skin, the non-metallic panels can be moulded so as to form at least two angular walls in one block. By this way, there is no separation of the structural panels at each angles of the container 1, as it will be better described below. Furthermore, the non-metallic panels of the structural arrangement comprise fibres, such as glass or carbon fibres, which are preferably oriented so as to cross an angle between two contiguous walls made of one block. The panels of the structural arrangement, or some of them, may comprise additional reinforcing fibbers, or tails, or any other material known to improve the mechanical performances of the panel. A panel of the structural arrangement may be for example of a type of prepreg composite material.

A panel of the structural arrangement may be in particular a composite prepreg or equivalent prepared combination of a matrix and reinforcing Fiber material for industrial use. The matrix may be chosen according to the needs. It is for example a plastic material, like duroplastic epoxy resin. The matrix system is preferably adapted for low pressure and low temperature curing. The viscosity of the material preferably remains low at curing temperature. The reinforcing fibres may be chosen according to the needs.

For example, the fibres may comprise or be arranged in an even composition, like twill 2×2, or combined. In case of combined fibbers, they can be combined unidirectionally, or form multiaxial or bidirectional fabrics. The type of reinforcing fibbers can also be selected by the skilled practitioner according to the needs. They can be selected among E-Glass, S-Glass, Carbon, Aramid or combination thereof. The area weight is preferably comprised between 120 and 1500 kg/m². The resulting composite material can be a prepreg having nominal resin content from 20 to 65 weight %.

The insulating material 112 may be selected among any known insulating material having the properties above-defined, in particular in terms of density and thermal conductivity. It is understood that a foam is not a preferred insulating material 112 since the density and/or the thermal conductivity may be not homogenous or precisely controllable. The insulating material is thus preferably under rigid panel, prepared prior the manufacturing of the present container 1 according to any suitable process. For example, the insulating material may be a material comprising or based on polyisocyanurate (PIR). It can be packaged as panels having predefined dimensions, having square or rectangular shape and a predefined thickness. The thickness may be defined according to the expected overall thermal performances of the container. A thickness of 2 to 5 cm, or from 4 to 10 cm, or from 6 to 20 cm can be for example selected depending on the needs. Globally, the overall thickness of the walls of the container, including the structural arrangement 110, 111, and the insulating material 112, should correspond to the applicable regulation.

The container 1 may comprise one or more intermediate layers 201 between the base 20 and the lower part of the box.

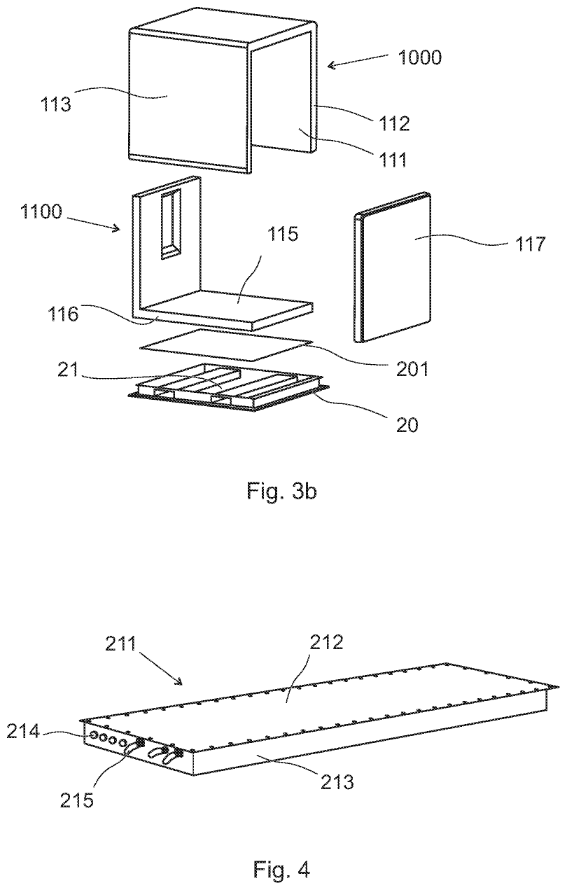

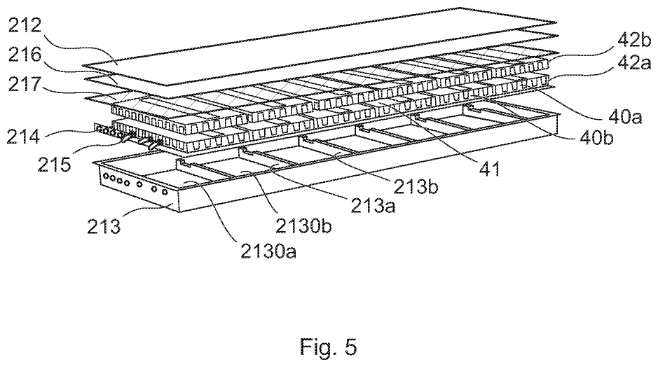

It is to be understood that the thermal insulation above described allows to reduce the dimensions and the weight of the active thermal system, including the batteries 210. There is thus a double benefit of the disclosed container 1. The disclosed container 1 can however comprise the insulated walls as described above, combined to a traditional TCS. The present container however preferably comprises a low consumption optimized TCS 14. The batteries module 210 lodged in the central housing 21 are packed in a rigid tray 211 having edges 213 and a lid 212 so that they are protected against chocs and water (FIG. 4). The tray 211 can be in metal, in composite material or in a suitable hard polymer. The height of the edges 211 of the tray 213 is at least equal to the thickness of the batteries module 210. The tray 211 thus prevents the batteries 210 to be in contact with water, in case of rain and bad storage conditions of the container 1. It also contains any accidental leakage from the batteries 210. The tray 211 comprises at least one internal wall 213a, 213b defining separate internal areas 2130a, 2130b (FIG. 5). The internal walls limit the contamination from one internal area to the other one, and thus improves the safety of the batteries 210 in case of failure or water contamination.

The tray 211 comprises at least one external electrical connection means 215 to allow an easy plugging operation with the EPS or any other electrical devices of the container 1. This external electrical connection is internally linked to the batteries contained in the tray 211, either individually or through a common connection.

The tray 211 may in addition comprise one or more air permeable devices 214, allowing exchange of air and/or humidity between the internal space of the tray 211 and the outside environment, while preventing the passage of liquids. Such device can be for example a breather valve (GorTex valve). The tray 211, when tightly closed with the lid 212 can thus resist to pressure variations without deformation.

The exploded view of FIG. 5 better shows the arrangement of the battery cells within the tray 211. A set of several battery cells are packed together to form at least one battery module 40a, 40b. For example, a set of 40 battery cells can form a battery module 40a, 40b. Several battery modules 40a, 40b are combined to form the full power pack inside the tray 211 . . . . For example, 6 battery modules can be combined to provided a battery pack of 240 battery cells. In a given battery module 40a, 40b, the battery cells are placed at a horizontal position. In other words, their larger dimension is oriented according to a horizontal direction. Such an arrangement allows to minimize the thickness of the power pack and save storage space in the payload compartment of the container 1. Several battery modules 40a, 40b can be aligned in the tray 211 in a way that each internal areas 2130a, 2130b receives a battery module 40a, 40b. Each battery module is arranged within a fixation box 42. Such a fixation box can have for example, a lower part 42a, permanently fixed to the tray 211, and a cover part 42b that can be removably fixed to the lower part 42a so as to maintain the corresponding battery module. The material of the fixation boxes is preferably non electrostatic and electrically insulated. A fixation box also acts as a second protective layer, in particular in case of internal leakage or external liquid contamination.

The tray 211 may comprise one or several sealing elements 217 and additional protection elements 216. Such a protection element may be a compression foam. For example, the power pack can comprise one long external O-ring sealing.

The modular arrangement of the battery modules 40a, 40b allows to conveniently adapt the autonomy and/or the weight of the container 1. Since the batteries are placed at a central position, one or several battery modules 40a, 40b can be removed without providing a significant unsymmetrical weight load. No counterweight is necessary.

Depending on the anticipated energy consumption, the number of battery modules 40a, 40b can easily be adapted.

The battery cells are preferably selected among the Nickel-metal hydride (NiMH) cell type. They are rechargeable.

The solar panels are electrically connected to the Electrical Power System (EPS) 15 of the corresponding container 1. A container according to the present disclosure may in addition comprise an electrical connection means accessible from outside the container and allowing to connect two containers 1, or to connect a container to a supply source. Several containers 1 can thus be interconnected and/or branched on the power supply of the local infrastructure of an airport. The combined solar panels thus allows to better distribute the energy to several containers 1. This can be convenient in case battery level of some container is lower than a certain threshold. Such an arrangement also allows to combine containers which are equipped with solar panels, with containers which do not comprise solar panels.

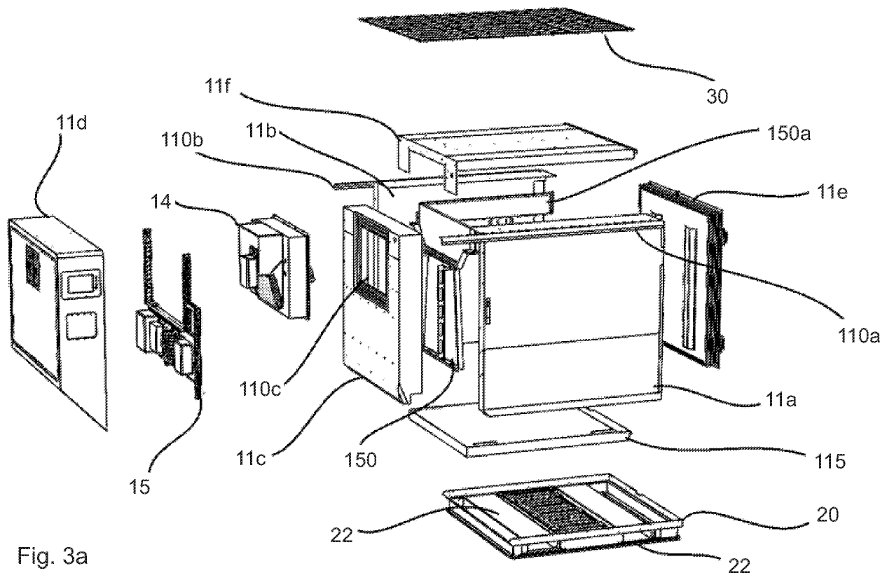

An embodiment of the present disclosure is better shown in FIG. 3a. The container according to such arrangement comprises a first 11a and a second 11b lateral walls, which are thermally insulated, as above described. The container also comprises a top wall 11f, defining the roof, and a third lateral wall 11e, comprising an openable part to access the storage volume 12. The top wall 11f as well as the other walls of the container are made of composite material or comprise composite material. All the top wall and the lateral walls 11a, 11b, 11d comprise the insulating material above mentioned sandwiched between two non-metallic panels. The container 1 may comprise one or several internal walls 11c, providing distinct compartments inside the container 1. For example, an internal wall 11c may be provided as the fourth lateral wall, which closes the storage volume 12, together with the first 11a, the second 11b and the third 11e lateral walls. Some profiles 110a, 110b are advantageously provided at the top edge of the lateral walls. Such profiles may be made of polymer and glued on the walls. The internal wall 11c preferably comprises the insulating material 112 above mentioned, sandwiched between two panels 110, 111. The internal wall 11c separates the storage volume 12 from a technical volume 13, comprising at least some of the technical devices used for actively controlling the temperature inside the container 1. The technical volume 13 comprises a Temperature Control System (TCS) 14 and an Electrical Power System (EPS) 15, adapted to manage the energy from various sources, such as battery or solar panels. The technical volume 13 comprises the necessary compressor, evaporator, condenser, the SCS and the corresponding pipes and fans. The technical volume 13 may also be used to lodge one or several extra battery modules. The internal wall 11c is provided with one or more openings 110c allowing a controlled communication between the storage volume 12 and the technical volume 13. Such opening 110c may be grids, potentially comprising filters and allowing air flows. Alternatively, the opening 110c may be holes adapted for the passage of pipes. The technical volume may be closed by an external wall 11d. Such an external wall 11d can be a cover. The wall 11d may also be known as an equipment bay.

The container 1 comprises air distribution ducts 150, 150a, allowing to actively modulate the thermal conditions inside the storage volume 12. The air distribution ducts 150, 150a, are in flow communication with the TCS 14 through the internal wall 11c.

According to another embodiment better shown in FIG. 3b, the container 1 comprises a U-shape structure 1000 defining the top and two opposite lateral walls 11. The U-shape structure 1000 is a one bloc piece having an external layer 113 and an insulating material 112 associated to the external layer 113. It can in addition have an internal layer 111, being of same or different material than the external layer 113. The external layer 113 comprises fibres, either carbon or glass fibres, they are organized to avoid any disruption between the lateral walls and the top surface of the U-shape element 1000. The fibres within the non-metallic material are oriented according to a privilege direction crossing the angles between the lateral walls and the top surface.

The container 1 has also a L-shape structure 1100, adapted to be combined to the U-shape structure 1000. It is a one bloc piece forming the lower part of the box and a third lateral wall. The L-shape structure 1100 also comprises an insulating material 112, above described.

One or both of the U-shape 1000 and the L-shape 1100 elements may comprise in addition local reinforcing structural elements such as transversal beams.

The present invention further encompasses a process for manufacturing a container 1. At least it relates to a process for manufacturing the insulating walls.

The present process comprises a step of moulding structural plates or panels based on fibre-containing material such as a glass fibre material. Usual moulding conditions can be applied depending on the material and the needs. The fibres are oriented along a privilege direction. The structural panels correspond to the layers used in the more rigid part of the walls 11 and surrounding the insulating material 112. Panel may be flat and have an homogenous thickness. The moulding step allows however different tridimensionality shapes of the panels. For example, the U-shape and L-shape structures can be provided according to the present process. In particular, a panel of the structural arrangement may be moulded so as to define two or more contiguous walls of the container 1. To this end, the panels can be angled and form a ridge. Two contiguous walls may define two lateral walls, or a lateral wall and the top, or a lateral wall and the bottom.

For example, the thickness of a plate or panel may vary locally and precisely in order to create local reinforcements. This allows to have an optimized structure in terms of resistance vs weight. In case an angle is formed, the fibres of the final structure may be oriented in an orthogonal direction, compared to the direction of the ridge resulting from the angular position of the panels.

The manufacturing process comprises a combination step of combining the plates or panel above-mentioned with an insulating material. The insulating material 112 is preferably also under the form of panels.

The combination step includes contacting a panel of the structural arrangement such as first panel 110 or a second panel 111 above defined, and the insulating material 112 under a predetermined pressure at a predetermined temperature. The combination is made so that all the surface of the structural panel is covered with the insulating material 112. In case of a large structural panel 110, 111, several panels of insulating material 112 can be juxtaposed so as to cover all the surface. The conditions of the combination step are determined according to the nature, dimensions, of the insulating material 112 and/or the panels of structural arrangement 110, 111. In particular, the conditions are determined so as to guaranty an homogenous adhesion of the panels of insulating material 112 and the corresponding panels of the structural arrangement 110, 111. The conditions also allow to prevent any delamination within the panels of insulating material 112. In other words, the integrity of the insulating material should be preserved during the manufacturing, and also after, during use and aging of the container 1. The predetermined pressure may be comprised between 0.5 bars and around 4 or 2 bars. It can be for example around 1 bar. The pressure applied to the plates from outside, may be combined to, or followed with a vacuum applied to the internal structure. Such a vacuum may be for example comprised between around −0.1 bar and −0.8 bar, for example around −0.2 or −0.3 bar. A curing temperature is applied during part or all of the pressure application and/or vacuum application. The curing temperature is adapted according to the nature of the handled materials. As an example, a temperature comprised between 90° C. and 150° C., preferably between 100° C. and 120° C., may be applied. The curing temperature may be constant and corresponding to a predetermined value. Alternatively, the curing temperature may have a profile moving from several values over time. The isolating material is preferably presented as a bloc of material having a parallelepipedal shape. The isolating material has preferably the density and/or the thermal conductivity described above. The insulating material 112 is as above defined. It is preferably based on polyurethane foam. It can be for example a PIR, or a PIR premium based product, such as PIR Premium Plus. The pressure and thermal conditions are adapted to avoid any degradation of the isolated material, and in particular to guarantee that the integrity of the isolating material remains stable during the process and over time. Delamination of the isolating material is more particularly avoided.

During the combination step, the isolating material may be combined to only one panel, corresponding for example to the external walls of the container. Alternatively, the insulating material may be combined to two panels so as to be arranged in sandwich between these two panels. Such a sandwich arrangement may be performed in a single step or in two successive steps under same or different conditions. The insulating material is combined to the non-metallic fibre containing material under the manufacturing conditions. It is in particular not necessary to add any additional adhesive material. The pressure conditions and the temperature conditions are adapted to provide a good and reliable adhesion of the insulating material to the non-metallic fibre containing plates.

For example, the manufacturing conditions may be particularly adapted for prepreg composite materials allowing to adhere to the panels of insulating material 112. However, other related materials can be used.

The present process preferably not comprises any step of inserting a layer of additional material between the panels of structural arrangement 110, 111 and the panels of insulating material 112, so that a direct adhesion occurs during the process. It is however still possible to include such an intermediate layer, for example, for improving the adhesion between the panels of the structural arrangement 110, 111 and the panels of insulating material 112. For example, a thin prepreg intermediate layer may be used to this end. Alternatively, one or both of the panels of structural arrangement 110, 111 and panels of insulating material 112 may be coated with a layer of adhesive material prior the combination step above described.

The above-mentioned embodiments are not understood to be mutually exclusive. They all describe the present invention and can be combined or mixed where applicable.

### EXAMPLE

The following cure cycle descriptions define general process parameter limits. A specific curing shall be defined by the manufacturer during prototyping utilizing local machinery and process control.

### Cure Cycle for Sandwich Lay-Up Containing PIR Sandwich

heat-up rate: 0.5-4 K/min.
pressure difference: 0.5 to 1.5 bar with minimal vacuum of −0.3 bar
temperature: 80 to 110° C.+tolerance range +−5 K
minimal curing time for specific curing temperatures: 415′ at 85° C.; 175′ at 95° C.; 100′ at 105° C.; 65′ at 115° C.
cool-down rate: 1-5 K/min to at least 60° C. or lower
   Cure Cycle for Monolithic or Sandwich Lay-Up without PIR
heat-up rate: 0.5-5 K/min
pressure difference: 1 to 4 bar with minimal vacuum of −0.3 bar.
temperature: 90 to 135° C.+tolerance range +−5 K
minimal curing time for specific curing temperatures: 175′ at 95° C.; 100′ at 105° C.; 65′ at 115° C.
cool-down rate: 1-5 K/min to at least 60° C. or lower.

The following aspects are also part of the present disclosure: in the present container, the batteries cells are packed in a tray 211 arranged in a central housing 21, the tray having edges 213 and a lid 212, wherein the height of the edges is equal or larger than the thickness of the batteries cells.

In the present container, the tray 211 further comprises at least one internal wall 213a, 213b defining internal areas 2130a, 2130b. The batteries cells are packed as 6 battery modules (40a, 40b) to form a power pack. Each battery module 40a, 40b is arranged in a corresponding internal area 2130a, 2130b of the tray 211.

The tray 211 can comprises an external electrical connection means 215 internally linked to the batteries 210. The tray 211 can further comprise one or more air permeable devices 214 such as a breather valve, allowing exchange of air and/or humidity between the internal space of the tray 211 and the outside environment, while preventing the passage of liquids.

The battery cells can be of NiMH type and arranged so that their larger dimension is oriented in an horizontal plan.

The container can comprise independent insulated walls and a top insulated wall.

The container can further comprise one or several solar panels 30 being removable or not.

The present process for manufacturing a container comprises a moulding step to provide non-metallic fibre containing panels, wherein the fibres are oriented according to a privilege direction.

The process comprises a combination step of combining said panel with an insulating material 112, preferably without adhesive material.

The container here described denotes any thermo Controlled Container commonly used with aircrafts. They include different size and type of container, such as the RKN type, the RAP type container and any other recognized type.

### REFERENCE SYMBOLS IN THE FIGURES

1 Container
10 Storage box
11 Walls
110 First panel of the structural arrangement
111 Second panel of the structural arrangement
1000 U-Shape structure
1100 L-Shape structure
112 Isolating material
12 Internal storage volume
13 Technical volume
14 Temperature Control System
20 Base
21 Central housing
210 Batterie modules
211 Tray
212 Lid
213 Edges
213a, 213b Internal walls
2130a, 2130b Internal areas
214 Permeable devices
215 Connection means
216 Protection elements
217 Sealing elements
22 Forklift tunnels
30 Solar panels
40a, 40b Battery Modules
42 Fixation box
42a Lower part
42b Cover part

1. Container comprising a storage box arranged on a base comprising at least two forklift tunnels and a central housing between two forklift tunnels, a temperature control system integrated to the container comprising at least a compressor, and an Electrical Power System comprising at least battery cells feeding the temperature control system, said storage box further comprising walls defining an internal storage volume, said walls comprising an insulating material providing a thermal isolation and a structural arrangement providing the mechanical resistance of the walls, wherein:
the structural arrangement comprises non-metallic fibre containing material,
the insulating material is selected among at least one panel of material having a density lower than 60 kg/m³,
the insulating material homogeneously recovers all the surface of the structural arrangement, and
said walls are sandwich assemblies wherein the panels of insulating material are comprised between a first panel and a second panel of the structural arrangement.

2. Container according to claim 1, wherein the thermal conductivity of the isolating material is lower than 0.03 W/mK.

3. Container according to claim 1, wherein the insulating material has a density of around 30 kg/m³ and thermal conductivity of around 0.02 W/mK, 0.018 W/mK or lower.

4. Container according to claim 1, wherein one or each one of the first and the second panels of the structural arrangement form two or more contiguous walls in one piece.

5. Container according to claim 4, wherein said two or more contiguous walls form a ridge resulting from the angular position of the corresponding panels, and wherein the fibres within the non-metallic material are oriented according to a privilege direction crossing the angles between said contiguous walls.

6. Container according to claim 1, wherein the space between a first and a second panels of the structural element is free of reinforcing element so as to avoid any lack of insulating material.

7. Container according to claim 1, wherein said non-metallic fibre containing material denotes a composite material comprising E-Glass, S-Glass, Carbon, Aramid or a combination thereof.

8. Container according to claim 7, said non-metallic fibre containing material further comprising reinforcing fibres or veil or fabric,

9. Container according to claim 1, wherein said non-metallic fibre containing material is a prepreg composite material.

10. Container according to claim 1, wherein said insulating material comprises or is based on polyisocyanurate (PIR).

11. Container according to claim 1, wherein said batteries cells are packed in a tray arranged in a central housing, the tray having edges and a lid, wherein the height of the edges is equal or larger than the thickness of the batteries cells.

12. Container according to claim 7, wherein the tray further comprises at least one internal wall defining internal areas and wherein each battery module is arranged in a corresponding internal area of the tray.

13. Container according to claim 11, wherein said tray further comprises one or more air permeable devices allowing exchange of air and/or humidity between the internal space of the tray and the outside environment, while preventing the passage of liquids.

14. Container according to claim 1, wherein said battery cells are of NiMH type and arranged so that their larger dimension is oriented in an horizontal plan.

15. Process for manufacturing a container according to claim 1, comprising:
a moulding step to provide non-metallic fibre containing panels forming a first and a second panels of a structural arrangement,
a combination step of combining at least one of said first and a second panels with an insulating material,
wherein said insulating material is under the form of rigid and homogenous panels, so that the insulating panels covers all the surface of said at least one of said first and a second panels.

16. Process according to claim 15, wherein combination step is performed at a temperature comprised between 90° C. and 150° C.

17. Process according to claim 15, wherein combination step is performed at a pressure comprised between 0.5 and 4 bars, with a vacuum applied to the internal structure comprised between −0.1 bar and −0.8 bar.
